(19) United States
(12) Patent Application Publication
(10) Pub. No.: US 2007/0288602 A1
(43) Pub. Date: Dec. 13, 2007

(54) Interest-based communities

(75) Inventor: Neelakantan Sundaresan, Mountain View, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 11/636,257

(22) Filed: Dec. 8, 2006

Related U.S. Application Data
(60) Provisional application No. 60/804,380, filed on Jun. 9, 2006.
(60) Provisional application No. 60/821,254, filed on Aug. 2, 2006.

(51) Int. Cl. G06F 15/16

(52) U.S. Cl. 709/219

(57) ABSTRACT

Embodiments of a method and system for interest based communities are disclosed. A community is accessed within a networked system. The community includes community content and a group of users of the networked system with a similar interest. The community content is related to the similar interest and available for viewing by the group of users. The community content is maintained for access within the networked system. Other embodiments are also disclosed.

### RELATED APPLICATIONS

This application claims the priority benefit of U.S. Provisional Application No. 60/804,380, filed Jun. 9, 2006 and U.S. Provisional Application No. 60/821,254, filed Aug. 2, 2006, both of which are incorporated herein by reference.

### TECHNICAL FIELD

The present application relates generally to the technical field of data-processing and, in one specific example, to a method and system for creating and maintaining electronic data pertaining to communities.

### BACKGROUND

Existing social based communities may be used to identify and communicate with other users of the communities for purposes such as commerce, entertainment and networking. The social based communities generally grow by word of mouth among their users. There may be limited control over how the content within the community is provided to the users.

### BRIEF DESCRIPTION OF THE DRAWINGS

Some embodiments are illustrated by way of example and not limitation in the figures of the accompanying drawings in which:

FIG. 1 is a network diagram depicting a network system, according to one embodiment, having a client server architecture configured for exchanging data over a network;

FIG. 2 is a block diagram illustrating an example embodiment of multiple network and marketplace applications, which are provided as part of the network-based marketplace;

FIG. 3 is a high-level entity relationship diagram, in accordance with an example embodiment, illustrating various tables that may be maintained within one or more databases;

FIG. 4 is a block diagram of an example database deployed in the system;

FIG. 5 is a flowchart illustrating a method for community management in accordance with an example embodiment;

FIG. 6 is a flowchart illustrating a method for establishing a community according to an example embodiment;

FIG. 7 is a flowchart illustrating a method for identifying and creating a community according to an example embodiment;

FIG. 8 is a block diagram of an example hierarchy tree;

FIG. 9 is a flowchart illustrating a method for conducting a text/relationship analysis according to an example embodiment;

FIG. 10 is a flowchart illustrating a method for suffix tree clustering according to an example embodiment;

FIG. 11 is a block diagram of an example suffix tree;

FIG. 12 is a block diagram of an example merged cluster graph;

FIG. 13 is a block diagram of an example suffix tree;

FIG. 14 is a block diagram of an example suffix tree;

FIG. 15 is a flowchart illustrating a method for community selection of a user according to an example embodiment;

FIG. 16 is a flowchart illustrating a method for notifying a user about a community according to an example embodiment;

FIG. 17 is a flowchart illustrating a method for providing community content used in an example embodiment;

FIG. 18 is a flowchart illustrating s a method for selecting community tags used in an example embodiment;

FIG. 19 is a block diagram of an example user interface; and

FIG. 20 is a block diagram diagrammatic representation of machine in the example form of a computer system within which a set of instructions, for causing the machine to perform any one or more of the methodologies discussed herein, may be executed.

### DETAILED DESCRIPTION

Example methods and systems for creating and maintaining interest based communities are described. In the following description, for purposes of explanation, numerous specific details are set forth in order to provide a thorough understanding of example embodiments. It will be evident, however, to one skilled in the art that the present invention may be practiced without these specific details

A community may be created and maintained by identifying a community, selecting initial candidates for the community, providing community content and refining the community. The community may be identified by conducting a text plus relationship analysis that may include assessing relationships among a cluster of keywords that may be representative of a perspective community. Candidates for the community may be assessed based on user activities and relationships. Community content may be presented based on a weighted average calculation considering the recency and relevancy of the postings and repuatation of the posters. Community tags may be used to identify other communities of interest.

It may be appreciated that suggesting communities with beneficial information to a user based on the user's potential interest in the communities may, for example, encourage the user to engage in further transactions of which the user might not otherwise have been aware. Moreover, establishing communities with valuable members may, for example, encourage further transactions between members of the community.

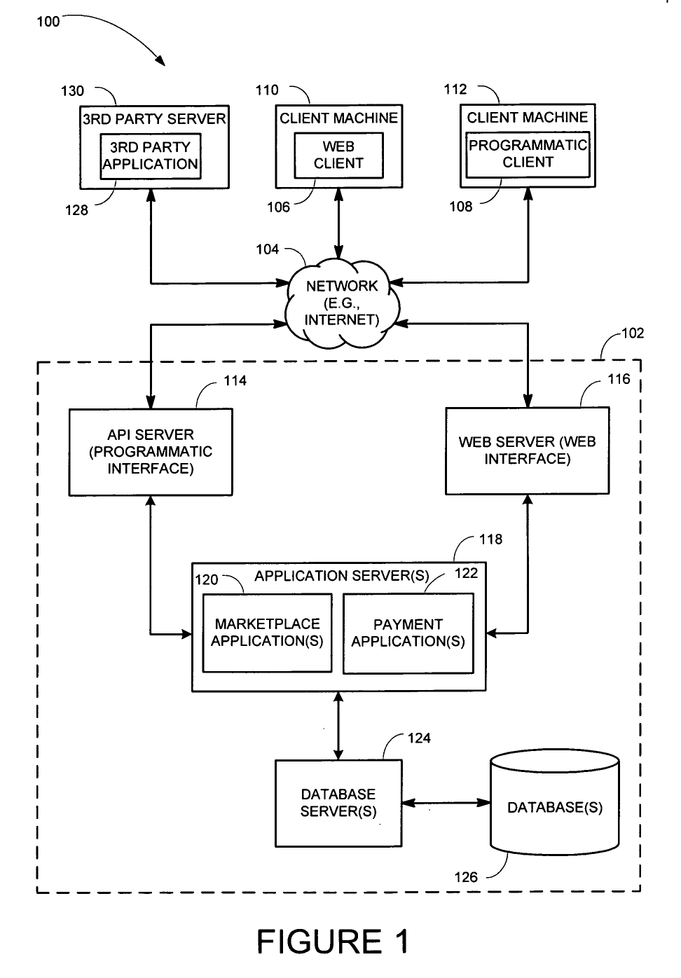

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

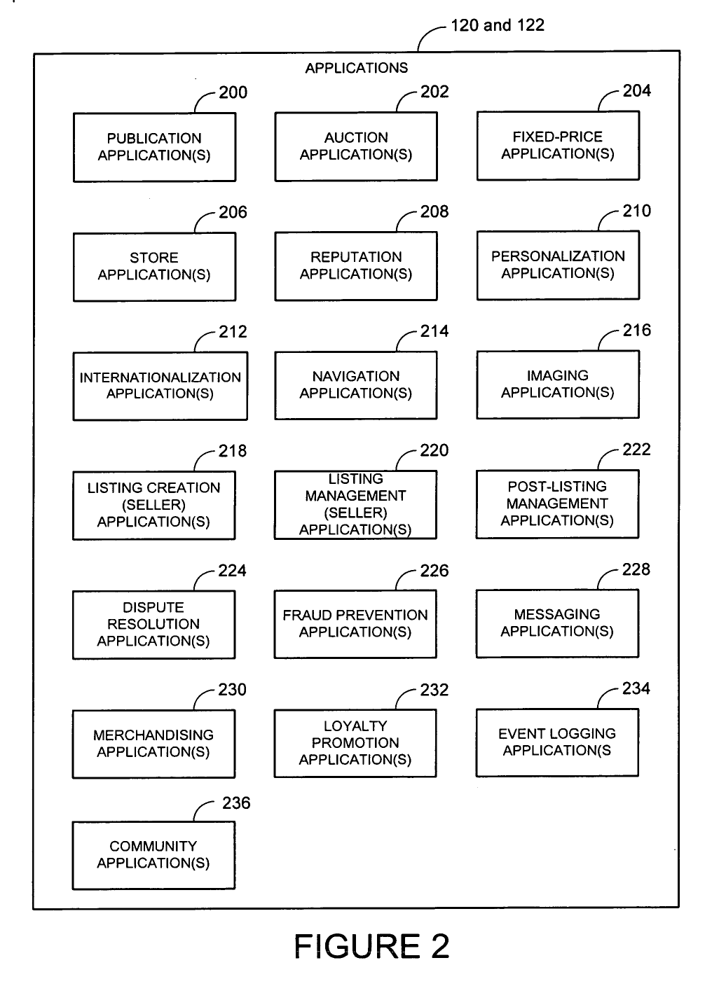

FIG. 2 is a block diagram illustrating multiple applications 120 and 122 that, in one example embodiment, are provided as part of the networked system 102 (see FIG. 1). The applications 120 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 126 via the database servers 124.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized and/or localized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browse application may allow users to browse various category, catalogue, or system inventory structures according to which listings may be classified within the networked system 102. Various other navigation applications may be provided to supplement the search and browsing applications.

In order to make listings, available via the networked system 102, as visually informing and attractive as possible, the marketplace applications 120 may include one or more imaging applications 216 utilizing which users may upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such messages for example advising users regarding the status of listings at the networked system 102 (e.g., providing “outbid” notices to bidders during an auction process or to provide promotional and merchandising information to users). Respective messaging applications 228 may utilize any one have a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotions points for each transaction established and/or concluded with a particular seller, and be offered a reward for which accumulated loyalty points can be redeemed.

Event logging applications 234 may monitor information regarding events that occur within the networked system 102 (e.g., interaction between the users and the networked system 102). For example, event logging applications 234 may listen on a bus of the networked system 102. In an example embodiment, the event information may be logged to the database 126 and/or streamed (e.g., to the bus) and/or logged to a file.

Community applications 236 may facilitate creation and maintenance of communities of users of the networked system 102. For example, the community applications 236 may enable users of networked system 102 to identify and/or communicate with other users having similar interests (e.g., to enable sharing of community content). An example embodiment of a methods for creating and maintaining communities is described in greater detail below.

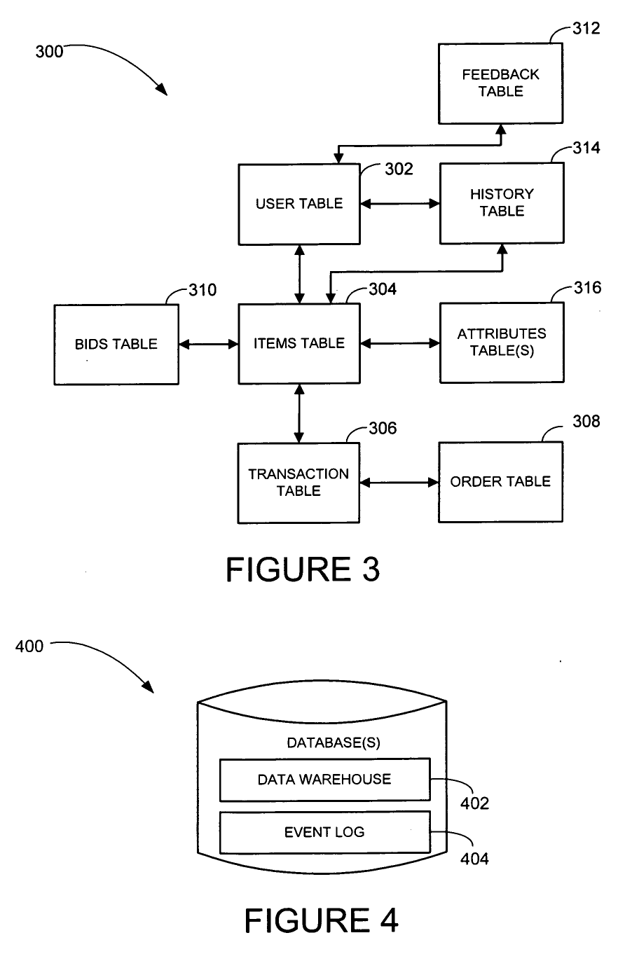

FIG. 3 is a high-level entity-relationship diagram, illustrating various tables 300 that may be maintained within the databases 126, and that are utilized by and support the applications 120 and 122 (see FIG. 1). A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items (e.g., products and/or services) that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, each order record being associated with an order for a good and/or service. Each order, in turn, may be with respect to one or more transactions for which records exist within the transaction table 306.

Bid records within a bids table 310 each relate to a bid received at the networked system 102 in connection with an auction-format listing supported by an auction application 202. A feedback table 312 is utilized by one or more reputation applications 208 (see FIG. 2), in one example embodiment, to construct and maintain reputation information concerning users. A history table 314 maintains a history of transactions to which a user has been a party. One or more attribute tables 316 record attribute information pertaining to items for which records exist within the items table 304. Considering only a single example of such an attribute, the attribute tables 316 may indicate a currency attribute associated with a particular item, the currency attribute identifying the currency of a price for the relevant item as specified in by a seller.

Referring to FIG. 4, a database 400 according to an example embodiment is illustrated. In an example embodiment, the functionality of the database 126 (see FIG. 1) may include the functionality of the database 400.

The database 400 may include a data warehouse 402 and an event log 404. The data warehouse 402 may archive information regarding transactions (e.g., transaction data) within the networked system 102 (see FIG. 1). For example, a price listing of an item (e.g., a good or service), a plurality of bids for the item, information (e.g., name and feedback) regarding a user that sells and/or purchases the item, a title of the item, a category of the item, and the like may be stored for each transaction in the data warehouse 402 in a transaction document. In an example embodiment, information may be accessed and/or stored from the tables 302-316 (see FIG. 3) by the data warehouse 402.

The event log 404 may archive information regarding the use of networked system 102 by users. For example, the event log 404 may include event data including a user's login to the networked system 102, product searched and categories browsed within the marketplace applications 120, a user disconnecting and reconnecting to the networked system 102, bidding activity, purchasing activity, and the like. In an example embodiment, the event log may archive session information for a user. It may be appreciated that the event log 404 may include other information regarding the use of the networked system 102. In an example embodiment, information may be accessed and/or stored from the tables 302-316 (see FIG. 3) by the event log 404.

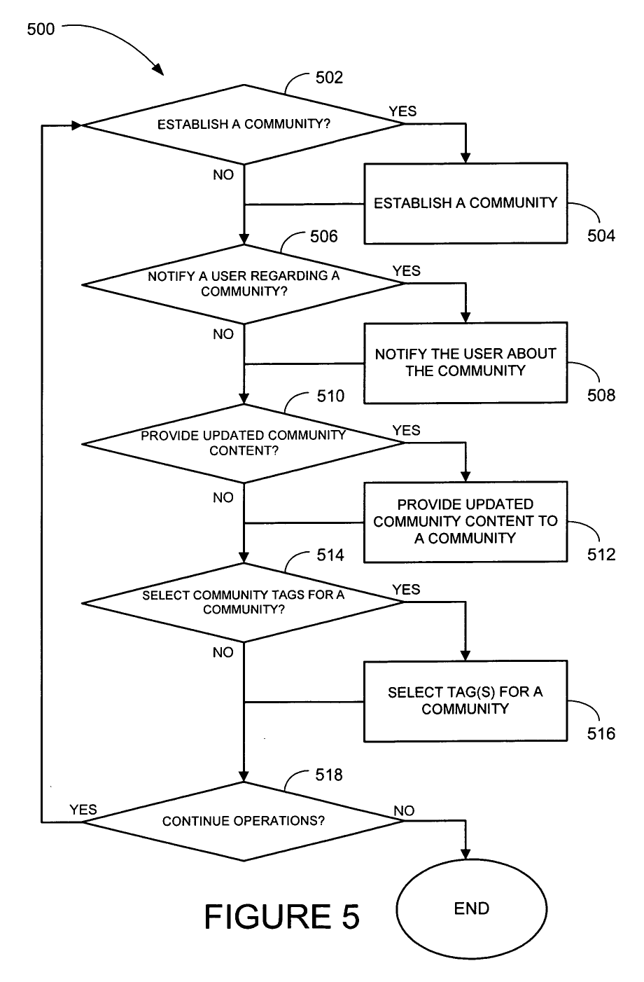

Referring to FIG. 5, a method 500 for community management in accordance with an example embodiment is illustrated. In an example embodiment, the method 500 may be performed by the community application 236 (see FIG. 2).

A determination may be made at decision block 502 as to whether to establish a community (e.g., a group of users with similar interests that may communicate with one another). If the determination is made to establish a community, the community may be established at block 504. An example embodiment of establishing a community is described in greater detail below. If no community is to be established at decision block 502 or after completing the operations at block 504, the method 500 may proceed to decision block 506.

At decision block 506, a determination may be made as to whether to notify a user not part of the community regarding existence of a community (e.g., where a community should be suggested to the user). If the user is to be notified, the user may be notified regarding the community at block 508. An example embodiment of notifying the user regarding a community is described in greater detail below. If the user is not be notified of the community at decision block 506 or upon completion of the operations at block 508, the method 500 may proceed to decision block 510.

A determination may be made at decision block 510 as to whether updated community content may be provided to a community. If the updated community content is to be provided to a community (e.g., community content may be maintained for the community and/or new community content may be added for the community), the community may be provided with updated community content at block 512. An example embodiment of providing updated community content is described in greater detail below. If updated community content is not to be provided to a community at decision block 510 or upon completion of the operations at block 512, the method 500 may proceed to decision block 514.

At decision block 514, a determination may be made as to whether one or more community tags should be selected for a community. If community tags are to be selected, the community tags may be selected for a community at block 516. An example embodiment of selecting community tags is described in greater detail below. If the community tags are not to be selected at decision block 514 or upon completion of the operations at block 516, the method 500 may proceed to decision block 518.

A determination may be made at decision block 518 whether to continue operations of the method 500. If operations are to continue, the method 500 may return to decision block 502. If operations of the method 500 are not to continue, the method 500 may terminate.

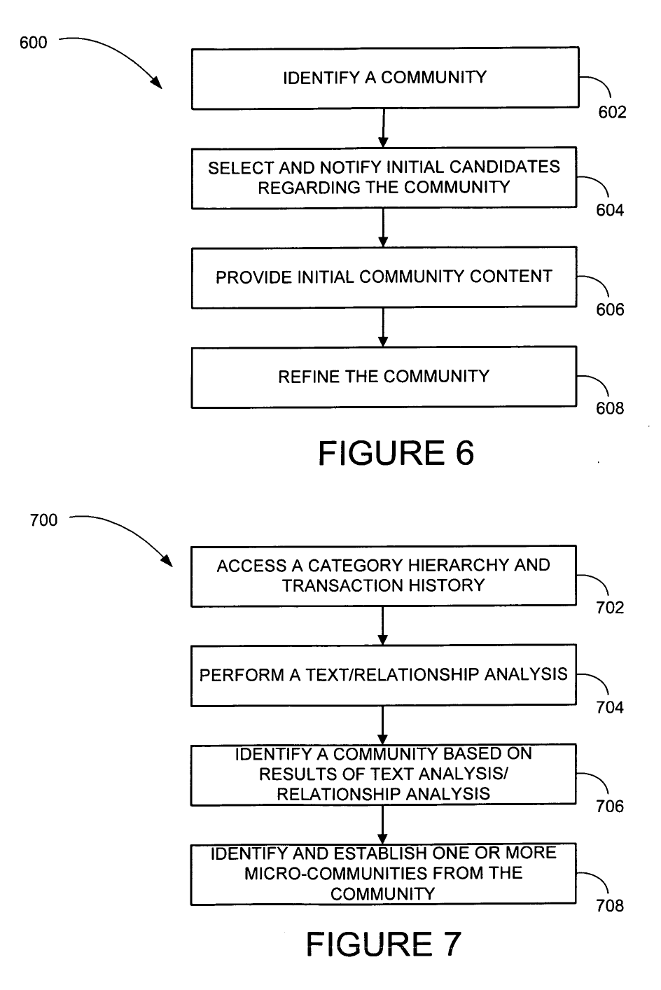

Referring to FIG. 6, a method 600 for establishing a community in accordance with an example embodiment is illustrated. In an example embodiment, the method 600 may be performed at block 504 (see FIG. 5) and/or by the community application 236 (see FIG. 2).

A community (e.g., a social networking community) may be identified at block 602. For example, transaction data from the data warehouse 402 and/or event data in the event log 404 (see FIG. 4) from user activities including repeat purchaser activity, repeat browsers activity and/or repeat sales activity may be parsed to identify more key terms and/or one or more phrases that may be representative of a community. An example embodiment of a method for identifying a community is described in greater detail below.

At block 604, a number of initial candidates (e.g., potential joiners of the community) may be selected and notified regarding the community. In an example embodiment, the initial candidates from among a candidate pool (e.g., all users of the networked system 102) to join the community. For example, the initial candidates may be selected from among a top number of persons (e.g., twenty users with the highest number of past purchases and/or transactions). An example embodiment for selecting a number of initial candidates is described in greater detail below.

The community may be provided with initial community content at block 606. In an example embodiment, the initial community content may include content from auction listings, reviews, guides, articles, user posts, third party sources, and the like. An example embodiment for a method of providing the community with community content is described in greater detail below.

It should be appreciated that the operations at block 604 and block 606 may occur in reverse order.

The community may optionally be refined at block 608. For example, a particular community may be folded, split and/or terminated at block 608 based on the use of a particular community.

In an example embodiment, an organizational structure of a community may be modified at block 608. For example, a user may be appointed to a role of an administrator (or a moderator) for the users of the community and/or a user that fails to successfully moderate a particular community may be removed as the administrator and another user of the community may be appointed.

Upon completion of the operations at block 608, the method 600 may terminate.

Referring to FIG. 7, a method 700 for identifying a community in accordance with an example embodiment is illustrated. In an example embodiment, the method 700 may be performed at block 602 (see FIG. 6).

A category hierarchy and/or a transaction history may be accessed at block 702. The category hierarchy may include a number of categories of different item types available through the networked system 102. For example, the category hierarchy may be stored in a hierarchical format and based on similar interests, similar items, and the like. The category hierarchy may be automatically generated (e.g., by the community applications 236 of FIG. 2) based on activity of the users of the networked system 102 (see FIG. 1), manually generated by one or more users of the networked system 102, accessed from the third party application 128, or the like. An example embodiment of the category hierarchy is described in greater detail below.

The transaction history may include data related to transactions (e.g., transaction data) within the networked system 102 and may include information regarding users that are repeat purchasers of items in the networked system 102, repeat browsers of items in the networked system 102, and/or make repeat sales to the same buyer within the networked system 102. For example, the transaction history may be contained within the data warehouse 402, event log 404, and/or the tables 302-316 (see FIGS. 3 and 4).

A text/relationship analysis may be performed on the transaction history using the category hierarchy at block 704 to identify one or more key terms and/or phrases representative of users within the networked system 102 with a similar interest. In an example embodiment, the results of the text/relationship analysis may create one or more community tags. An example embodiment of a method for performing the text/relationship analysis is described in greater detail below.

One or more communities may be identified based on the results of the text/relationship analysis (e.g., key terms and/or phrases) at block 706. For example, the community may be based upon a similar interest in associated items (e.g., goods and/or services).

At block 708, one or more micro-communities may be identified from the community. In an example embodiment, the one or more community tags of the community may be classified to determine whether one or more micro-communities may be formed.

In an example embodiment, a micro-community may be a smaller form of the community where a few users are selected from among the group of users of the community that are interested in a specific topic selected from among topics of interest to the group of users of the networked system 102. For example, in a community of “COCA-COLA bottle cap collectors” a micro-community of “COCA-COLA bottle caps from year 2000 collectors” may be created. In an example embodiment, a micro-community may be created at block 708 when a micro-community threshold size for a micro-community is met.

In an example embodiment, a micro-community may be identified based upon at least one or more micro-community factors selected from a group of micro-community factors including search terms used within the networked system 102, search terms plus view item patterns within the networked system 102, search terms plus view items divided by bid patterns within the networked system 102, favorite sellers (explicit and implicit) within the networked system 102, users buying from a common favorite seller within the networked system 102, and/or locality of the users within the networked system 102. Other micro-community factors may also be used.

In an example embodiment, the users of the networked system 102 whose activities and/or relationships are deemed significant enough (e.g., as may be defined by a predetermined micro-community threshold) to generate a community (or micro-community) may be invited as initial members of the community (or micro-community).

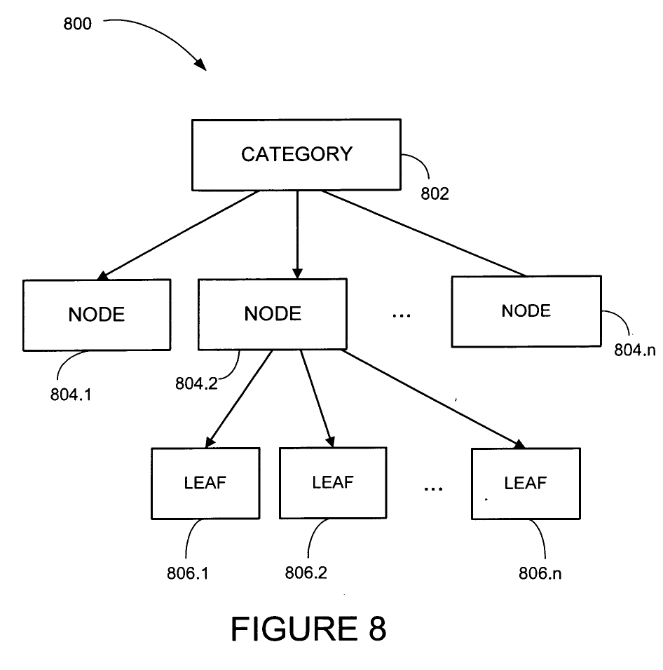

Referring to FIG. 8, a category hierarchy 800 in accordance with an example embodiment is illustrated. In an example embodiment, the category hierarchy 800 may be accessed during the operations at block 702 (see FIG. 7)

The category hierarchy 800 may include a root 802, a plurality of internal nodes 804.1-804.n and a plurality of leaves 806.1-806.n. The root 802 may define a category of items. For example, the root 802 may identify “electronics category”. It should be appreciated that the category hierarchy 800 may include a plurality of roots 802 to identify a number of product categories in the category hierarchy 800.

The plurality of internal nodes 804.1-804.n may identify a plurality of subcategories of items. For example, the plurality of subcategories for the category of electronics may include computers, PDAs and home electronics. It should be appreciated that multiple levels of plurality of nodes 804.1-804.n may be used (e.g., sub-nodes) to further define items within the product category.

The plurality of leaves 806.1-806.n may include an item within the category hierarchy. For example, the products of the subcategory PDA may include Palm Pilot, BlackBerry, and iPod.

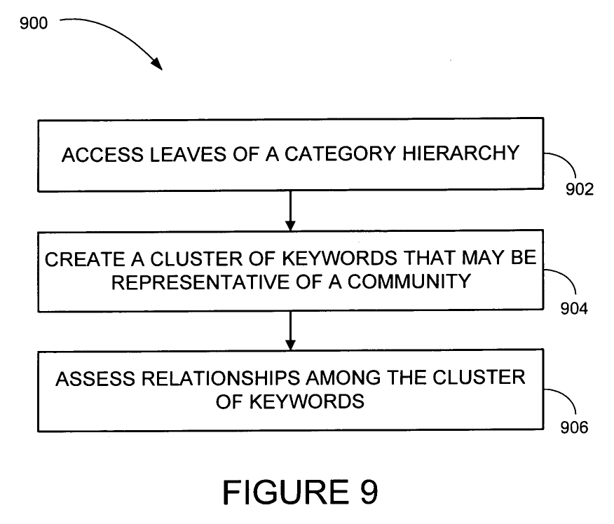

Referring to FIG. 9, a method 900 for conducting a text/relationship analysis in accordance with an example embodiment is illustrated. In an example embodiment, the method 900 may be performed at block 704 (see FIG. 7).

The plurality of leaves 806.1-806.n of the category hierarchy 800 (see FIG. 8) may be accessed at block 902.

A cluster of keywords that may be representative of a community may be created at block 904. The cluster of keywords may be selected (e.g., by a clustering algorithm) from the plurality of leaves 706.1-706.n and/or the plurality of nodes 704.1-704.n. For example, keyword extraction may be conducted to create the cluster of keywords.

In an example embodiment, the cluster of keywords may be within a single category (e.g., electronics) of items of the category hierarchy 800, and/or the cluster of keywords may spawn more than one category of items of the category hierarchy. For example, Marilyn Monroe items may be available in categories for videos, posters, photographs and clothes.

An assessment of relationships among the cluster of keywords may be performed at block 906 to select one or more keywords from among the cluster of keywords as a key term or a phrase representative of users within the networked system 102 with a similar interest. The relationships may include the interactions between users of the networked system 102 (see FIG. 1) that use keywords of the cluster of keywords as contained within the transaction history. For example, the interactions between the users of the networked system 102 may be social interactions and/or transaction interactions contained within the transaction history. Categories, transactions and/or user relationships may be considered when assessing relationships among the cluster of keywords.

In an example embodiment, the assessment may performing a tf (term frequency)*idf (inverse document frequency) analysis on the cluster of keywords to select from among the cluster of keywords a key term or a phrase representative of users within the networked system 102 with a similar interest.

In an example embodiment, the keywords may form community tags for topics for a theme in the community. For example, a volume, minimal co-occurrence, proximity may be used on the cluster of keywords to create community tags for a community. A minimum number of transactions within the category may be considered for creation.

In an example embodiment, the operations at block 906 may determine keywords that are used frequently by the users of the networked system 102 (see FIG. 1) to identify categories of users that are likely to be interested in a particular community.

Upon completion of the operations at block 906, the method 900 may terminate.

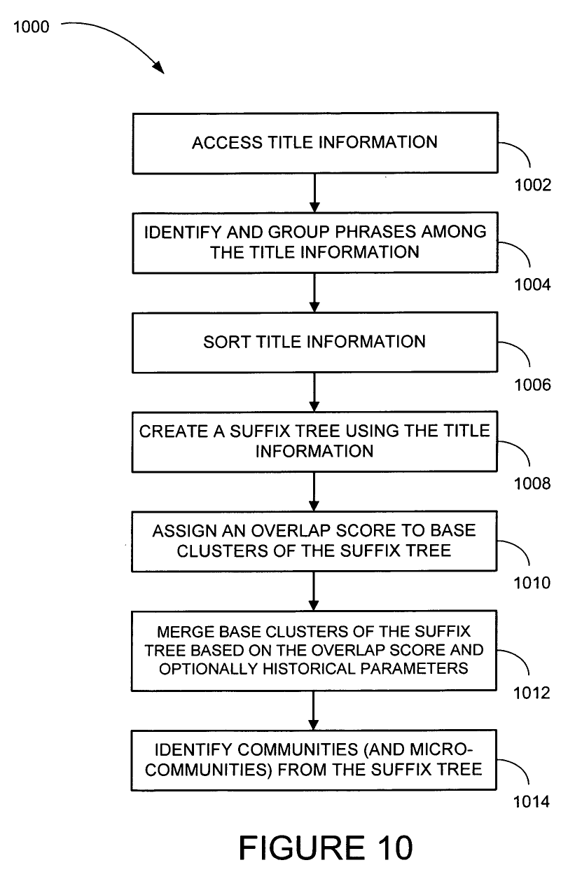

Referring to FIG. 10, a method 1000 for suffix tree clustering according to an example embodiment is illustrated. In an example embodiment, the method 1000 may be performed at block 602 (see FIG. 6) to identify and create a community. In an example embodiment, the method 1000 may be used for data mining in an information retrieval system. For example, the method 1000 may be used to extract class information, group, and organize text and hypertext content, group and organize web search results into manageable clusters “on-the-fly”, and the like.

Title information for a number of documents may be accessed at block 1002. For example, the title information may include a title of a transaction document (e.g., containing information regarding a transaction through the networked system 102) accessed from the data warehouse 402 (see FIG. 4) and/or the title of a non-transaction document such as a text document (e.g., a Microsoft Word document) or a hypertext document (e.g., a search results page).

The title information may optionally be parsed by excluding noise words (e.g., terms that may not contribute to defining a community) from the title information consideration at block 1002. For example, noise words may include “a”, “the”, “new”, “cheap”, “shrink wrapped”, and the like.

The title information may also optionally be parsed by identifying and grouping phrases (e.g., terms that mostly occur together) among the title information at block 1004. For example, the terms “pepsi cola” may be grouped as a phrase (e.g., and thereby be treated as a term by the method 1000). Identifying and grouping phrases may make a suffix tree more compact (e.g., less nodes) as compared to a suffix tree without identifying and grouping phrases.

In an example embodiment, phrases may be identified and grouped by their differing occurrences. By way of example, “Pepsi Cola” may be also listed as “pepsi-cola” or “pepsicola” and these terms may be normalized these into a single term like “pepsi-cola”. Additional stemming and/or synonym normalization (e.g., using a synonym for a word) may also be performed at block 1004.

It should be appreciated that the use of the method 1000 for data mining to access titles of non-transaction documents as the title information accessed that the transaction history used may include access, search, and/or retrieval history of the documents in the information retrieval system.

In an example embodiment, product aspects from the suffix tree may be grouped together. Relationship between the phrases in the title information and/or breaking the phrases into attributes and/or values may also be performed at block 1004.

The title information may also optionally be parsed by sorting the title information at block 1006. For example, the terms of the title information may be sorted in ascending or descending order.

By way of a example, an iPod Nano may be listed with the title information as “IPod Nano 4G White New”, “Apple IPod Nano 2 GB MP3 Player”, “New Apple IPod Nano Black Retail Box”, “Apple IPod Nano Black 2 GB MP3 Player”, and the like. The key phrases from the listing may be extracted (e.g., during the operations at block 1004) and the title information may then be in a fixed order (e.g., Apple, iPod Nano, MP3 Player, 4G, 2G, Black, White, New, and Retail box.).

A suffix tree may be created using the title information (e.g., parsed title information or unparsed title information) at block 1008. The suffix tree may be a compact suffix trie including a number of terms from the title information.

By way of example, a suffix tree of a string S of terms from the title information may be a compact trie containing all the suffixes of S. The suffix tree may be a rooted directed tree, where each internal node has at least 2 children. Each edge of the trie may be labeled with a non-empty substring of S. The label of a node may be a concatenation of the labels of the edges on the path from the root to that node. The suffix tree may have a compact property, such that no two edges out of the same node have edge labels that begin with the same term.

In an example embodiment, a trie may be a tree for storing strings in which there is one node for every common prefix, and a compact trie may be a trie in which nonbranching subtrees leading to leaf nodes are cut off.

In an example embodiment, transaction data (e.g., category of the item, the buyer and seller information (name, feedback), and transaction date) for the document may be stored along with the title information in the suffix tree. The order of occurrence of the terms of the title information may optionally be retained in the suffix tree.

An overlap score (e.g., indicating terms shared between each instance of the title information in the suffix tree) may be assigned to base clusters of the suffix tree at block 1010 to reflect an amount of overlap. For example, each base cluster of the suffix tree may be assigned an overlap score that is a function of the number of documents it contains and the terms that make up the title information for the documents.

By way of example, if Q reflects the set of base clusters and P reflects a set of all phrases, for a base cluster q in Q, with a phrase p in P, the score S may be given by:

S(q)=z|q|*f(|p|) where |q| is the number of documents in the base cluster q, and |p| is the number of words in p.

Base clusters of the suffix tree may be merged based on one or more merge criterion at block 1012. A comparison of a threshold overlap score with the overlap score overlap score may be used as merge criterion to identify clusters that are similar to each other so that the similar clusters may be merged during at block 1012. Clusters that have document sets that significantly overlap may be related to a same theme and may therefore be merged. For example, a threshold overlap score may be selected as the merge criterion. The overlap score may be compared against the threshold overlap score to determine whether the threshold overlap score is met.

By way of example, given two clusters qᵢ and qⱼ with sizes |qi| and |qj|, respectively, bi and bj may be considered ‘similar’ if |qi∩qj|/|bi|>μ and |qi∩qj|/|qj|>μ, where μ is a predefined threshold (e.g., fifty percent). The similarity may be defined as a function ζ(qi,qj)=1 if |qi∩qj|/|qi|>μ and |qi∩qj|/|qj|>μ, and =0.

Historical parameters such as a buyer-seller affinity, a transaction price, and the like may also optionally be used in determining whether clusters may be merged at block 1012.

For example, the historical parameters for merging clusters may include a buyer-seller affinity, a buyer-buyer affinity, and/or seller-seller affinity (e.g., with the networked system 102). The buyer-seller participation in a transaction may contribute to the merging of the cluster in the following ways (in decreasing order of weights). If Ci and Cj is the clusters under consideration for merging, t is the transaction, (b,s) is the buyer-seller pair, and Tij are the transactions that contribute to either Ci or Cj, the transactions may be considered in an order in which they took place (e.g., Tij={t1, t2, . . . , tn}). For any ti, the (b,s) may be the buyer-seller pair involved in the transaction, and the contribution of the transaction to the cluster definition may be defined in decreasing order of the following:
a. b and s have participated in a transaction ti-<ti;
b. b and s have not participated in a transaction before but some b′ and s have participated in a transaction ti-<ti;
c. b and s have not participated in a transaction but b and some s′ have participated in a transaction ti-<ti; and
d. b and s have never participated in any transaction prior to ti.

In an example embodiment, an implementation of the buyer-seller affinity may be by accessing a buyer-seller graph for a cluster and considering weight based on the ‘connectedness’ of the graph. For example, the connectedness of the transaction graph may be computed as follows: In a cluster with T transactions, a multi-graph with N nodes may be constructed where each node stands for a buyer or a seller in a transaction and T edges and each edge stands for a transaction connecting the buyer and the seller in that transaction. A minimum number of nodes in the graph may be 2 (e.g., in a case with one buyer and one seller that transact with each other). For example, each transaction may involve a separate buyer and a seller thereby creating 2N nodes. Closeness of the community Cl may be defined as a measure ½(N/T). Thereby, situations may range from where a value of the function is one (e.g., where each transaction is represented by a new pair of buyers and sellers) to a value approaching zero.

In an example embodiment, a normalizing function may be used (e.g., applied) to more closely reflect a parameter such as an affinity. For example, when there are more buyers than sellers, a typical seller may sell to more buyers. The buyer-seller affinity measure may not capture a desired buyer-seller ratio for use with the method 1000. To make a buyer and seller community more represented, a normalizing function such as min(|B|,|S|)/max(|B|,|S|) may be applied to a selected affinity.

Communities (and micro-communities) may optionally be identified from the suffix tree at block 1014.

Upon completion of the operations at block 1014, the method 1000 may terminate.

In an example embodiment when the method 1000 is used for data mining in an information retrieval system, the method 1000 may not perform the operations at block 1014, thereby terminating after completing the operations at block 1012.

In an example embodiment, the method 1000 may be a linear clustering technique and/or an incremental technique.

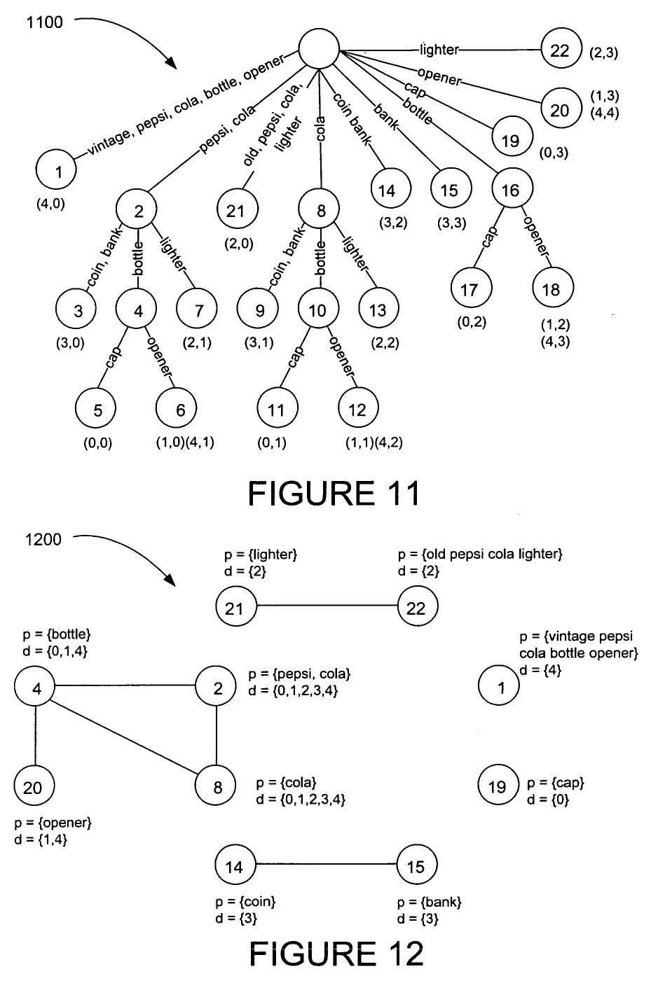

Referring to FIG. 11, a suffix tree 1100 according to an example embodiment is illustrated. In an example embodiment, the suffix tree 1100 (e.g., a compact suffix tree) may be created at block 1008 (see FIG. 10) with five sample title product strings (e.g., “Pepsi Cola Bottle Cap”, “Pepsi Cola Bottle Opener”, “Old Pepsi Cola Lighter”, “Pepsi Cola Coin Bank”, “Vintage Pepsi Cola Bottle Opener”).

Each node of the suffix tree 1100 may represent a base cluster of documents (e.g., a union of all documents at the leaves in the sub-tree under a node). Any path along the suffix tree 1100 may be a suffix of a selected string. The document label at the leaf of the suffix tree 1100 may indicate the document to which the suffix belongs (e.g., a suffix string can belong to more than one document) with the offset of where it starts.

For example, node 2 of the suffix tree has the label “Pepsi Cola”. The set of documents tagging the nodes in the subtree under this node form the document group for the base cluster represented by the node 2. In this example, the document group for the node 2 may include all the documents (e.g., documents 0, 1, 2, 3, and 4), all of which include the term “Pepsi Cola”.

A table may show for each intermediate node (and the base cluster under that node) the phrases and the documents that belong to the base cluster:

| Node | Phrases | Items/Documents |
|---|---|---|
| 1 | vintage pepsi cola | {4} |
| | bottle opener | |
| 2 | pepsi cola | {0, 1, 2, 3, 4} |
| 3 | bottle | {0, 1, 4} |
| 4 | Cola | {0, 1, 2, 3, 4} |
| 5 | Coin | {3} |
| 6 | Bank | {3} |
| 7 | Cap | {0} |
| 8 | opener | {1, 4} |
| 9 | old pepsi cola | {2} |
| | lighter | |
| 10 | lighter | {2} |

In an example embodiment, the document may indicate a transaction and may have, in addition to the title, information on the buyer, seller and the price. A document may indicate multiple transactions depending upon retained information. For example, if only the item title, buyer and seller information is retained, there may be multiple transactions between the same seller and buyer on the same product.

Referring to FIG. 12, a merged cluster graph 1200 according to an example embodiment is illustrated. In an example embodiment, the merged cluster graph 1200 may be created by the merging of base clusters from the suffix tree 1100 (see FIG. 11) from the operations at block 1012 (see FIG. 10). The merged cluster graph 1200 as illustrated may have a μ (e.g., an overlap score) selected to be 0.5. In a next iteration, the connected nodes may form a cluster.

The merging performed at block 1012 may results in the following 5 clusters:
Cluster 1={2} with phrases {“Old Pepsi Cola Lighter”, “Lighter”}, score=2
Cluster 2={4} with phrase {“Vintage Pepsi Cola Bottle Opener”}, score=1
Cluster 3={0} with phrase {“Cap”}, score=1
Cluster 4={3} with phrases {“Coin”, “Bank”}, score=2
Cluster 5={0, 1, 2, 3, 4} with phrases {“Pepsi Cola”, “Cola”, “Bottle”, “Opener”}, score=20

It may be appreciated that while the 5 example clusters may be built purely based on the title text and not based on any additional information available in the transaction. Historical parameters including price information may also be used as merging criteria. For example, clusters that are closer to each other in the price range may contribute as additional factor for merging criteria.

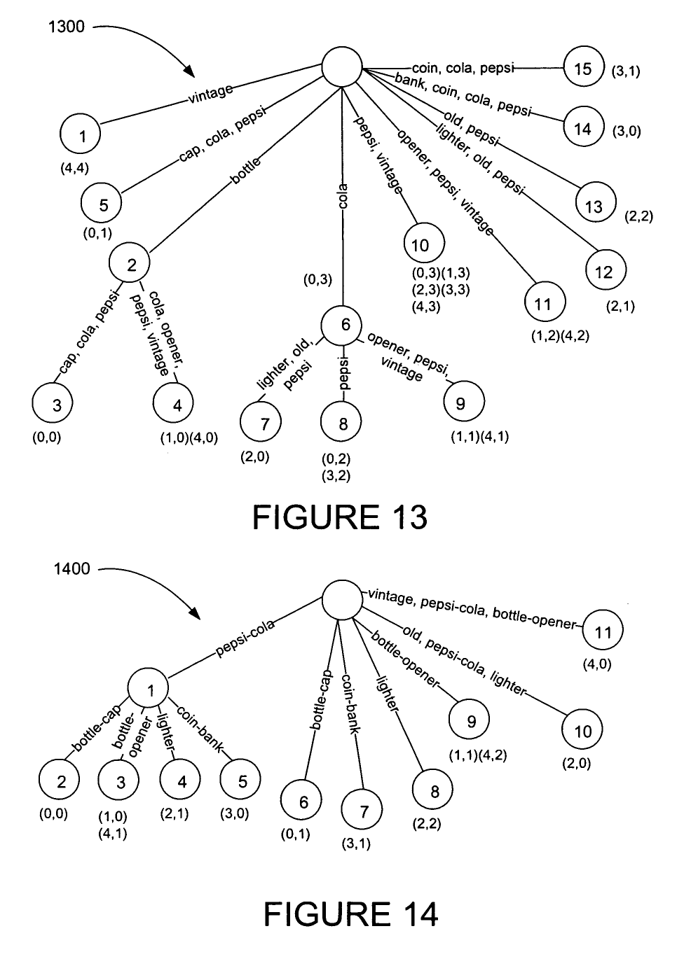

Referring to FIG. 13, a suffix tree 1300 according to an example embodiment is illustrated. The suffix tree 1300 may have the same sample title product strings as the suffix tree 1100 (see FIG. 11) but the suffix tree 1300 may include the application of the optional functionality of sorting title information (e.g., order the title information in a fixed order) of block 1006 (see FIG. 10). As shown, the suffix tree 1300 may have 15 nodes as compared to the 22 nodes of the suffix tree 1100.

Referring to FIG. 14, a suffix tree 1400 according to an example embodiment is illustrated. The suffix tree 1400 may have the same sample title product strings as the suffix tree 1100 (see FIG. 11) but the suffix tree 1400 may include the application of the optional functionality of identifying and grouping phrases of block 1004 (see FIG. 10). As shown, the suffix tree 1400 may have 11 nodes as compared to the 22 nodes of the suffix tree 1100.

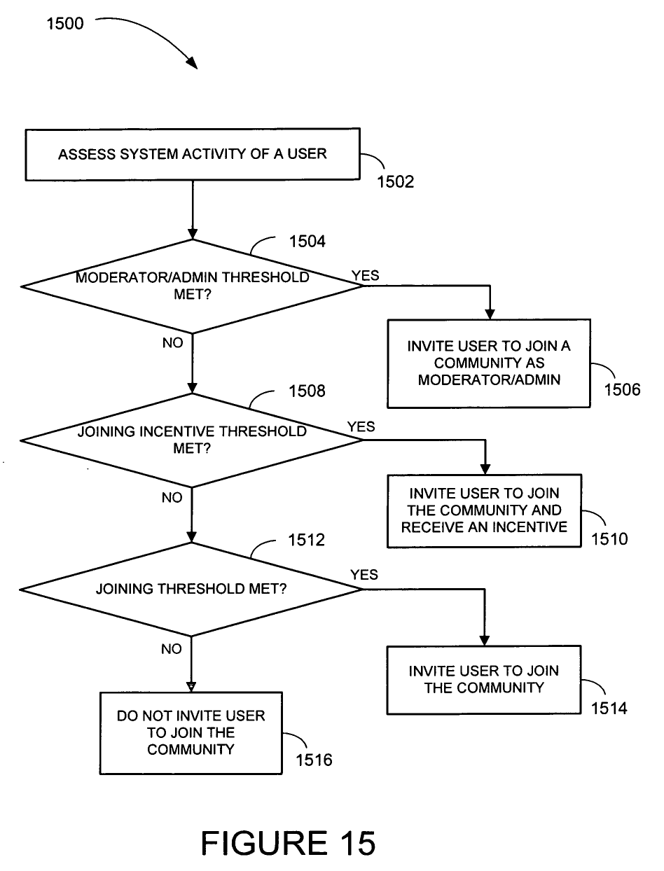

Referring to FIG. 15, a method 1500 for selecting and notifying candidates regarding a community according to an example embodiment is illustrated. In an example embodiment, the method 1500 may be performed at block 604 (see FIG. 6) for a number of the users in the networked system 102 (see FIG. 1).

An assessment of system activity (e.g., user activity within the networked system 102 and/or relationships between the user and other users of the networked system 102) may be performed at block 1502. For example, the system activity may be assessed by analyzing the data warehouse 402, event log 404, and/or the tables 302-316 (see FIGS. 3 and 4).

At decision block 1504, a determination may be made as to whether the system activity has met a moderator/administrator threshold (e.g., a first community threshold). If the system activity has met the moderator/administrator threshold, the user may be selected (e.g., invited) to join the community as a moderator and/or administrator at block 1506. If the system activity has not met the moderator/administrator threshold, the method 1500 may proceed to decision block 1508.

A determination may be made at decision block 1508 whether the system activity has met a joining with incentive threshold (e.g., a second community threshold). If the system activity has met the joining with incentive threshold, the user may be selected to join the community and provided with incentives for joining at block 1510. For example, the user may be given promotional items, bonus points, credit, or the like as an incentive to join. If the system activity has not met the joining with incentive threshold, the method 1500 may proceed to decision block 1512.

At decision block 1512, a determination may be made as to whether the system activity has met a joining threshold (e.g., a third community threshold). If the system activity has met the joining threshold, the user may be invited to join the community at block 1514. If the system activity has not met the joining threshold, the user may be not invited to join the community at block 1516.

Upon completing the operations at block 1506, block 1510, block 1514, or block 1516, the method 1500 may terminate.

In example embodiment, the joining with incentive threshold may be a greater threshold than the joining threshold, and the moderator/administrator threshold may be a greater threshold than the joining with incentive threshold.

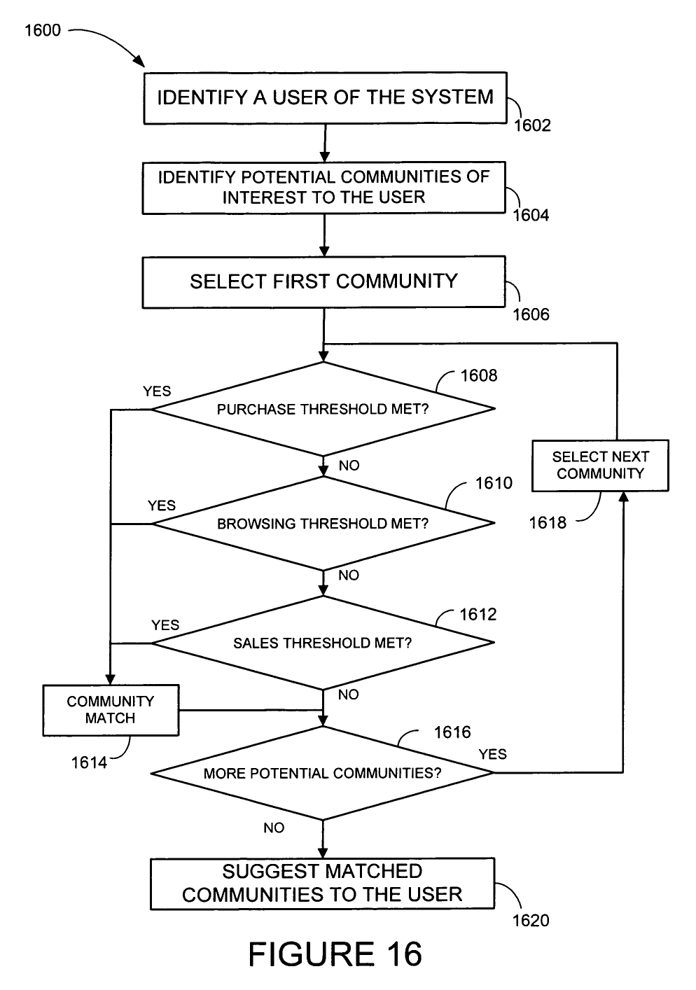

Referring to FIG. 16, a method 1600 for notifying a user about a community according to an example embodiment is shown. In an example embodiment, the method 1600 may be performed at block 508 (see FIG. 5).

A user of the networked system 102 may be identified at block 1602. In an example embodiment, the user may be identified by the networked system 102 (see FIG. 1) through a variety of sources such as through a user list, by another user of the system, a query made to the networked system 102, by the community application 236 (see FIG. 2) seeking candidates for a newly created community and/or a preexisting community, a new user joining the networked system 102, a user requesting communities of interest, and the like.

Potential communities of interest to a user may be identified at block 1604. The potential communities of interest to the user may optionally be identified by assessing system activity of the user to determine which communities are relevant to the system activity of the user.

A first community among the identified potential communities may be selected as a current community at block 1606.

At decision block 1608, a determination may be made as to whether a purchase threshold (e.g., a first activity threshold) is met for the current community. For example, the purchasing threshold may be based upon a frequency of occurrence of a number of purchases using the networked system 102, a volume of purchases using the networked system 102, and/or a total dollar amount of purchases using the networked system 102 with one or more terms relating to the community content.

If the purchase threshold is met, a community match may be made for the current community at block 1614 and the method 1600 may proceed to a decision block 1616. If the purchase threshold is not met at decision block 1608, the method 1600 may proceed to decision block 1610.

A determination may be made at decision block 1610 as to whether a browsing threshold (e.g., a second activity threshold) is met. For example, the browsing threshold may be based on a frequency of occurrence of when a user searches on items (e.g., a new item or a previous purchased item) within the networked system 102, when a user purchases an item from a first category but searches for an item in a corresponding category, and the like. If the browsing threshold is met, the community match may be made at block 1614 and the method 1600 may proceed to decision block 1616. If the browsing threshold is not met, the method 1600 may proceed to decision block 1612.

At decision block 1612, a determination may be made as to whether a sales threshold (e.g., a third activity threshold) is met. For example, the sales threshold may be based on a frequency of occurrence of a sale of an identified item type, a number of sales of the identified item type, or sales from the user totaling a predetermined dollar amount, and the like. If the sales threshold is met, the community match may be made at block 1614. If the sales threshold is not met or after completing the operations at block 1614, the method 1600 may proceed to decision block 1616.

A determination may be made at decision block 1616 as to whether there are more potential communities to evaluate. If there are more potential communities, a next community of the potential communities may be selected at block 1618 and the method 1600 may return to decision block 1608. If there are no more potential communities, the match communities may be suggested to the identified user (e.g., the identified user may be invited to join the community) at block 1620. In an example embodiment, when the community match is made at block 1614, the user may be invited to join the community.

Upon completion of the operations at block 1620, the method 1600 may terminate.

In an example embodiment, a user may accept or reject suggested communities and/or the user may be automatically joined to the suggested communities. It should also be appreciated that the matched communities may be suggested to the user during operations at block 1614 instead of during the operations at block 1620.

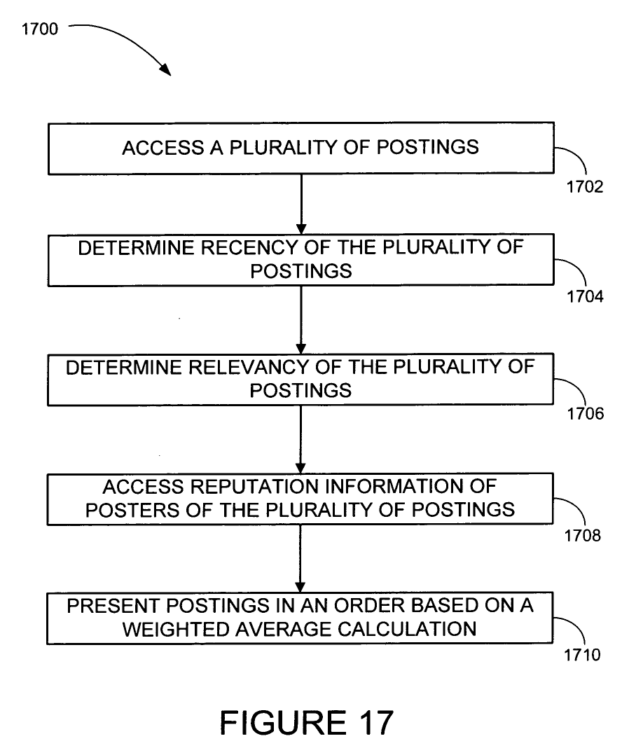

Referring to FIG. 17, a method 1700 for providing community content according to an example embodiment is shown. In an example embodiment, the method 1700 may be performed at block 512 and/or block 606 (see FIGS. 5 and 6).

A plurality of postings (e.g., a type of community content) for a community may be accessed at block 1702. For example, the plurality of postings may include a listing of items for sale at a fixed-price sale, a listing of items for sale by auction, a posting of a blog, a posting of a message board, and the like.

The recency of the plurality of postings may be determined at block 1704. The recency may be determined by a measure of time since a posting of the plurality of postings was made and/or modified. For example, recency may favor a more recent posting over an older posting, a most recent time of a posting (e.g., for a fixed-fee listing of an item), a closing time (e.g., for the sale of an item through auction), an alteration time of an item (e.g., putting the product on sale at a discount), and the like.

The relevancy of the plurality of postings (e.g., to the community) may be determined at block 1706. The relevancy may be determined by an evaluation of the relevantness of a posting is to the community. For example, the relevancy determination may be by having the plurality of postings incorporate a certain percentage (e.g., a high percentage) of terms incorporating community tags, considering other terms associated with the community, and the like.

Reputational information for the posters of the plurality of postings may be accessed at block 1708. The reputational information may determined by assessing a reputation for the number of posters. For example, reputational information may be based on a length of time by which the posters (e.g., a user that has posted content such as a message or listing in a community) have been a member of the community to enable posters that have been a member of the community longer may be given preference, a ranking of a user by the reputation application 208 (see FIG. 2), how well-known (e.g., seller may be considered well-known if the seller has a minimum feedback score within the seller's community) the seller is in the community, on other feedback from the users of the networked system 102 or members of the community, and the like.

The plurality of postings may be presented in an order based on a weighted average calculation of the values obtained from recency, relevancy, and/or reputational information at block 1710. For example, the values may be equally weighted or differently weighted (e.g., reputational information for high end products may be more heavily weighted). In an example embodiment, the weighted average calculation may also include a weighted calculation based on an assessment by users or members of the community on the plurality of postings.

In an example embodiment, only a subset of the plurality of postings may be posted. For example, the subset of the plurality of postings may a certain number (e.g., ten) of most applicable postings.

Upon completion of the operations at block 1710, the method 1700 may terminate.

In an example embodiment, the operations of block 1704, block 1706 and block 1708 may occur in any order and/or simultaneously.

In an example embodiment, the method 1700 may be performed for each new posting added to the plurality of postings (e.g., newly added postings may be evaluated against the previously presented postings) and/or for every posting of the plurality of postings (e.g., all postings are evaluated anew). However, other embodiments for accommodating newly added postings to the plurality of postings may also be used.

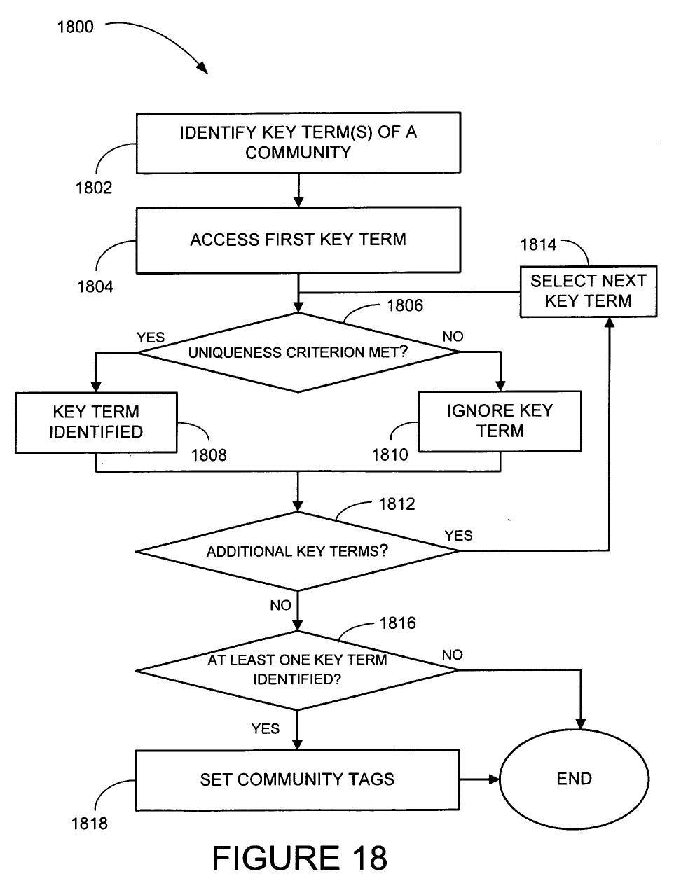

Referring to FIG. 18, a method 1800 for selecting community tags according to an example embodiment is shown. In an example embodiment, the method 1800 may be performed at block 516 (see FIG. 5).

Key terms of a community may be identified at block 1802. The key terms include terms that are representative of users with a similar interest. For example, key terms may include a community name of the community, may be identified by text mining techniques, and/or may be selected by an administrator of the community. The key terms may optionally not include terms that are generically used for a community such as collector, love, community, group, or the like.

An example text mining technique may establish that users that search, purchase and/or sell certain product may also be interested in other unrelated items. For example, users that search on diapers may also be interested in stereo headphones.

A first key term of a community may be accessed at block 1804.

At decision block 1806, a determination may be made whether a uniqueness criterion is met. For example, the uniqueness criterion may be that term is substantially unique to the community so that the term may be consider associated with the community.

If the uniqueness criterion is met, the key term may be identified at block 1808 and the method 1800 may proceed to decision block 1812. If the uniqueness criterion is not met at decision block 1806, the key term may ignored at block 1810 and the method may proceed to decision block 1812.

At decision block 1812, a determination may be made as to whether there are additional key terms to consider. If there are additional key terms, the next key term may be selected at block 1814 and the method 1800 may return to decision block 1806. If there are no additional key terms at decision block 1812, the method 1800 may proceed to decision block 1816.

A determination may be made at decision block 1816 as to whether at least one key term was identified. If at least one key term was identified, identified key terms may be set as community tags for the community at block 1818. If at least one key term was not identified at decision block 1816 or after completing the operations at block 1818, the method 1800 may terminate.

In an example embodiment, the method 1800 may use a phrase instead of a key term. The key terms identified at block 1818 may optionally be set as community labels for the community.

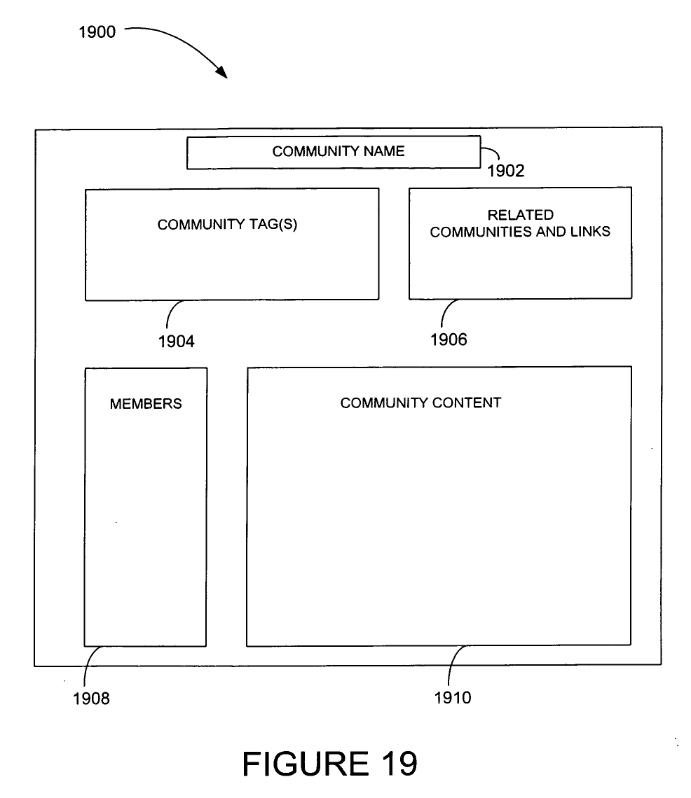

Referring to FIG. 19, a user interface 1900 according to an example embodiment is illustrated.

The user interface 1900 may include a community name 1902, community tags 1904, related communities and links 1906, members 1908 and community content 1910.

The community name 1902 may identify the name of the community. For example, the community name 1902 may be generated by the community application 236 (see FIG. 2), selected by one or more users of the community, and the like.

The community tags 1904 of the user interface 1900 may include terms relevant to the community. For example, a community for collectors of VOLTRON action figures may use the community tags “VOLTRON” and “ACTION FIGURE”, while a community for collectors of Billy Idol music might use the community tag “BILLY IDOL”.

The community tags 1904 may optionally be created by performing the operations at block 516, block 704, and/or block 906 and/or the method 1800 (see FIGS. 5, 7, 9 and 18), and may be created by the community application 236 (FIG. 2) and/or the users of a community.

A user may optionally have to meet a community threshold to be able to create and/or modify tags. For example, the community threshold may be that the user is a member of the community for a certain period of time, the user has posted a certain number of postings, the user has a moderator (and/or administrator) status, and the like. In an example embodiment, one or more moderators may be recommended by the community application 236 (e.g., by appointing users that have a status within network, be a member of the community for a certain period of time, and/or make a certain number of postings).

In an example embodiment, by selecting a particular community tag 1904 in the user interface 1900 the user may be presented with all communities containing the same community tag. For example, the selection of the community tag may suggest communities related to the current community.

In an example embodiment, community labels (not shown) may be provided through user interface 1900 instead of or in addition to community tags 1904.

The related communities and links 1906 may identify other communities of the networked system 102 (see FIG. 1) that may be of interest to a user of a particular community. For example, a related community may be identified by the community application 236 by identifying another community with a high percentage of matching community tags, determining another community subscribed to by current users of a particular community, one or more users of the community specifically identifying the related communities, and the like.

In an example embodiment, a link of the related communities and links may link to a web page or content. For example, the link may be a link to a third party website. The related communities and links 1906 may optionally include contextual advertising.

The members 1908 may identify users that have joined the community. The members 1908 of the community may optionally not be identified to a user unless the user has a verified identity (e.g., by logging into the networked system 102 and/or into a particular community).

The community content 1910 may include content from auction listings, reviews, guides, articles, user posts, blogs, other third party sources, and the like. The postings of community content may optionally be presented according to a method 1700 (see FIG. 17) for providing the community content 1910. Other embodiments for determining the community content 1910 may also be used.

In an example embodiment, a posting presented under the community content 1910 may include an abstract and a link to actual content and/or the actual content.

In an example embodiment, the user interface 1900 may modify a community by identifying new community tags, modifying community tags, modifying the description of the community, modifying the name of the community, defining new data sources, changing a primary or a secondary focus of the community content based on interest of the users, and the like.

The user interface 1900 may optionally be personalized for a user to enable presentation of the user interface 1900 as selected by a user and/or the networked system 102.

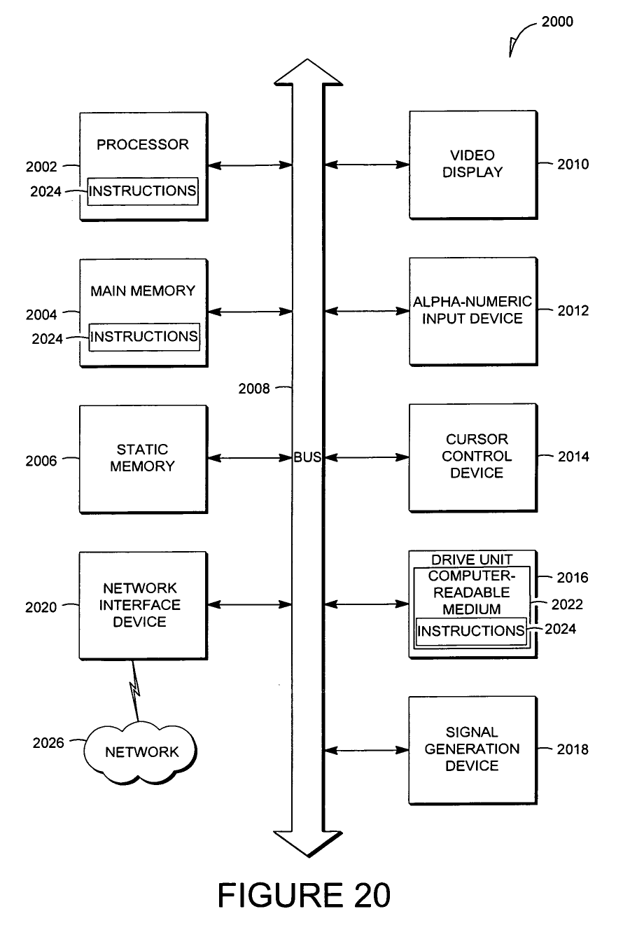

FIG. 20 shows a diagrammatic representation of machine in the example form of a computer system 2000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor 2002 (e.g., a central processing unit (CPU) a graphics processing unit (GPU) or both), a main memory 2004 and a static memory 2006, which communicate with each other via a bus 2008. The computer system 2000 may further include a video display unit 2010 (e.g., a liquid crystal display (LCD) or a cathode ray tube (CRT)). The computer system 2000 also includes an alphanumeric input device 2012 (e.g., a keyboard), a cursor control device 2014 (e.g., a mouse), a drive unit 2016, a signal generation device 2018 (e.g., a speaker) and a network interface device 2020.

The drive unit 2016 includes a machine-readable medium 2022 on which is stored one or more sets of instructions (e.g., software 2024) embodying any one or more of the methodologies or functions described herein. The software 2024 may also reside, completely or at least partially, within the main memory 2004 and/or within the processor 2002 during execution thereof by the computer system 2000, the main memory 2004 and the processor 2002 also constituting machine-readable media.

The software 2024 may further be transmitted or received over a network 2026 via the network interface device 2020.

While the machine-readable medium 2022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system for creating and maintaining interest based communities have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
accessing a community within a networked system, the community including community content and a group of users of the networked system with a similar interest, the community content related to the similar interest and available for viewing;
identifying a community tag for the community, the community tag enabling identification of the community within the networked system; and
maintaining the community content for access within the networked system.

2. The method of claim 1, further comprising:
selecting at least one activity threshold; and
notifying a user not among the group of users of the networked system of the existence of the community when the user has the similar interest and the at least one activity threshold is met.

3. The method of claim 2, wherein selecting at least one activity threshold comprises selecting at least one of:
a purchasing threshold, the purchasing threshold based upon a frequency of occurrence of at least one of a number of purchases using the networked system, a volume of purchases using the networked system, or a total dollar amount of purchases using the networked system with one or more terms relating to the community content;
a browsing threshold, the browsing threshold based upon a frequency of occurrence of at least one of when the user searches on an item within the networked system, or when the user purchases an item from a first category but searches for an item in a corresponding category, or
a sales threshold, the sales threshold based upon a frequency of occurrence of at least one of a sale of an identified item type, a number of sales of the identified item type, or sales from the user totaling a predetermined dollar amount.

4. The method of claim 1, further comprising:
identifying a micro-community, the micro-community including users interested in a specific topic selected from among topics of interest to the group of users of the networked system with the similar interest; and
establishing the micro-community from within the community when a predetermined threshold size for the micro-community is met.

5. The method of claim 4, wherein identifying a micro-community comprises:
identifying a micro-community based on a frequency of occurrence of at least one micro-community factor selected from a group of micro-community factors including search terms used within the networked system, search terms plus view item patterns within the networked system, search terms plus view items divided by bid patterns within the networked system, favorite sellers within the networked system, the users buying from a common favorite seller within the networked system, and locality of the users within the networked system.

6. The method of claim 1, wherein maintaining the community content for access within the networked system comprises:
accessing a plurality of postings, the postings including at least one of a listing of items for sale at a fixed-price sale, a listing of items for sale by auction, a posting of a blog, or a posting of a message board;
determining recency of the plurality of postings in a community, the recency determined by a measure of time since a posting of the plurality of postings was at least one of made or modified;
determining relevancy of the plurality of postings in the community;
determining reputational information of a number of posters of the plurality of postings in the community, the number of posters selected from among the group of users of the community, the reputational information determined by assessing a reputation for the number of posters;
performing a weighted average calculation based on the recency, the relevancy, and the reputational information; and
presenting the plurality of postings as community content in an order based on the weighted average calculation.

7. A method comprising:
identifying a community within the networked system, the community including a group of users of the networked system with a similar interest;
identifying at least one of a key term or a phrase for the community that is representative of the group of users with the similar interest;
selecting and notifying an initial candidate about the community, the initial candidate selected from among all users of the networked system; and
providing an initial portion of community content for the community, the community content related to the similar interest and available for viewing.

8. The method of claim 7, wherein identifying at least one of a key term or a phrase for the community that is representative of the group of users with the similar interest comprises:
parsing data from at least one of transaction data or event data to identify at least one of a key term or a phrase representative of the group of users within the networked system with the similar interest, the transaction data including information regarding transactions in the networked system, the event data including information regarding user activity within the network system.

9. The method of claim 7, wherein identifying at least one of a key term or a phrase for the community that is representative of the group of users with the similar interest comprises:
performing a text/relationship analysis on a transaction history using a category hierarchy to identify at least one of a key term or a phrase representative of the group of users within the networked system with the similar interest, the category hierarchy including a number of categories of different item types available through the networked system, the transaction history including at least one of information regarding users of the networked system that are repeat purchasers of items in the networked system, information regarding the users of the networked system that are repeat browsers of items in the networked system, or information regarding the users of the networked system that make repeat sales to a same buyer within the networked system.

10. The method of claim 9, wherein performing a text/relationship analysis on a transaction history comprises:
creating a cluster of keywords from the category hierarchy; and
assessing relationships among the cluster of keywords to select one or more keywords from among the cluster of keywords as at least one of the key term or the phrase representative of the group of users within the networked system with the similar interest, the relationships including interactions between the users of the networked system that use one or more keywords from the cluster of keywords.

11. The method of claim 10, wherein creating a cluster of keywords from a category hierarchy includes selecting a cluster of keywords from more than one category of items of the category hierarchy.

12. The method of claim 10, wherein assessing relationships among the cluster of keywords comprises:
performing a tf (term frequency)*idf (inverse document frequency) analysis on the cluster of keywords to select from among the cluster of keywords the key term or the phrase representative of the group of users within the networked system with the similar interest.

13. The method of claim 7, wherein identifying at least one of a key term or a phrase for the community that is representative of the group of users with the similar interest comprises:
accessing a number of documents from at least one of transaction data or event data, the transaction data including information regarding transactions in the networked system, the event data including information regarding user activity within the network system, each of the number of documents having title information, the title information including a title from each of the number of documents;
creating a suffix tree using the title information for the number of documents;
selecting a merge criterion; and
merging base clusters of the suffix tree based on the merge criterion to identify at least one of a key term or a phrase from among the number of documents that is representative of users with a similar interest.

14. The method of claim 7, wherein selecting and notifying an initial candidate about the community comprises:
accessing a level of system activity of a potential candidate of the community, the system activity including at least one of user activity within the networked system or relationships between the potential candidate and users of the networked system; and
inviting the potential candidate to join the community as an initial candidate when a community threshold is met.

15. The method of claim 14, wherein inviting the potential candidate to join the community when a community threshold is met comprises at least one of:
inviting the potential candidate to join the community as a moderator when a moderator threshold is met,
inviting the potential candidate to join the community as an administrator when an administrator threshold is met, or
inviting the potential candidate to join the community and providing and an incentive for joining the community when a joining incentive threshold is met.

16. A method comprising:
accessing a number of documents, each of the number of documents having title information, the title information including a title from each of the number of documents;
creating a suffix tree using the title information for the number of documents;
selecting a merge criterion; and
merging base clusters of the suffix tree based on the merge criterion to identify at least one of a key term or a phrase from among the number of documents.

17. The method of claim 16, wherein accessing a number of documents comprises:
accessing one or more non-transaction documents as the number of documents, the non-transaction documents including at least one of a text document or a hypertext document.

18. The method of claim 16, wherein accessing a number of documents further comprises:
accessing one or more transaction documents as the number of documents, the transaction documents including information regarding a transaction between a buyer and a seller through a networked system.

19. The method of claim 16, wherein creating a suffix tree using title information for the number of documents comprises:
parsing the title information for the number of documents; and
creating a suffix tree using the parsed title information for the number of documents.

20. The method of claim 19, wherein parsing the title information for the number of documents comprises at least one of:
removing one or more noise words from the title information, the one or more noise words including terms not used to define a community,
identifying and grouping one or more phrases among the title information of the number of documents, or
sorting the title information of the number of documents.

21. The method of claim 16, wherein creating a suffix tree using the title information for the number of documents comprises:
creating a compact suffix trie using the title information for the number of documents.

22. The method of claim 16, wherein selecting a merge criterion comprises:
assigning an overlap score to a number of base clusters of the suffix tree, the overlap score indicating terms shared between each instance of the title information in the suffix tree; and
selecting a comparison of the overlap score to a threshold overlap score as the merge criterion.

23. The method of claim 16, wherein selecting a merge criterion comprises:
assigning an overlap score to a number of base clusters of the suffix tree, the overlap score indicating terms shared between each instance of the title information in the suffix tree; and
selecting a comparison of a threshold overlap score with the overlap score and one or more historical parameters as the merge criterion, the overlap score compared against the threshold overlap score to determine whether the threshold overlap score is met, the one or more historical parameters including at least one of a buyer-seller affinity, a buyer-buyer affinity, or a seller-seller affinity in the networked system.

24. The method of claim 16, further comprising:
creating a community in a networked system using the at least one of a key term or a phrase from among the number of documents.

25. A method comprising:
accessing a plurality of postings, the postings including at least one of a listing of items for sale at a fixed-price, a listing of items for sale by auction, a blog, or a message board;
determining recency of the plurality of postings in a community, the recency determined by a measure of time since a posting of the plurality of postings was at least one of made or modified;
determining relevancy of the plurality of postings in the community;
determining reputational information of a number of posters of the plurality of postings in the community, the reputational information determined by assessing a reputation for the number of posters;
performing a weighted average calculation based on the recency, the relevancy, and the reputational information; and
presenting the plurality of postings for the community in an order based on the weighted average calculation.

26. A machine-readable medium comprising instructions, which when executed by a machine, cause the machine to:
access a community within a networked system, the community including community content and a group of users of the networked system with a similar interest, the community content related to the similar interest and available for viewing;
identify a community tag for the community, the community tag enabling identification of the community within the networked system; and
maintain the community content for access within the networked system.

27. The machine-readable medium of claim 26, further causing the machine to:
select at least one activity threshold; and
notify a user not among the group of users of the networked system of the existence of the community when the user has the similar interest and the at least one activity threshold is met.

28. The machine-readable medium of claim 26, further causing the machine to:
identify a micro-community, the micro-community including users interested in a specific topic selected from among topics of interest to the group of users of the networked system with the similar interest; and
establish the micro-community from within the community when a predetermined threshold size for the micro-community is met.

29. A machine-readable medium comprising instructions, which when executed by a machine, cause the machine to:
identify a community within the networked system, the community including a group of users of the networked system with a similar interest;
identify at least one of a key term or a phrase for the community that is representative of the group of users with the similar interest;
select and notify an initial candidate about the community, the initial candidate selected from among all users of the networked system; and
provide an initial portion of community content for the community, the community content related to the similar interest and available for viewing

30. The machine-readable medium of claim 29, wherein causing the machine to identify a community within the networked system causes the machine to:
perform a text/relationship analysis on a transaction history using a category hierarchy to identify at least one of a key term or a phrase representative of the group of users within the networked system with the similar interest, the category hierarchy including a number of categories of different item types available through the networked system, the transaction history including at least one of information regarding users of the networked system that are repeat purchasers of items in the networked system, information regarding the users of the networked system that are repeat browsers of items in the networked system, or information regarding the users of the networked system that make repeat sales to a same buyer within the networked system.

31. The machine-readable medium of claim 30, wherein causing the machine to perform a text/relationship analysis on a transaction history using a category hierarchy causes the machine to:
create a cluster of keywords from the category hierarchy; and
assess relationships among the cluster of keywords to select one or more keywords from among the cluster of keywords as the key term or the phrase representative of users within the networked system with the similar interest, the relationships including interactions between the users of the networked system that use one or more keywords from the cluster of keywords.

32. A machine-readable medium comprising instructions, which when executed by a machine, cause the machine to:
access a number of documents, each of the number of documents having title information, the title information including a title from each of the number of documents;
create a suffix tree using the title information for the number of documents;
select a merge criterion; and
merge base clusters of the suffix tree based on the merge criterion to identify at least one of a key term or a phrase from among the number of documents.

33. The machine-readable medium of claim 32, wherein causing the machine to create a suffix tree using the title information for the number of documents causes the machine to:
parse the title information for the number of documents; and
create a suffix tree using the parsed title information for the number of documents.

34. The machine-readable medium of claim 32, wherein causing the machine to select a merge criterion causes the machine to:
assign an overlap score to a number of base clusters of the suffix tree, the overlap score indicating terms shared between each instance of the title information in the suffix tree; and
select a comparison of a threshold overlap score with the overlap score as the merge criterion, the overlap score compared against the threshold overlap score to determine whether the threshold overlap score is met.

35. A machine-readable medium comprising instructions, which when executed by a machine, cause the machine to:
access a plurality of postings, the postings including at least one of a listing of items for sale at a fixed-price sale, a listing of items for sale by auction, a posting of a blog, or a posting of a message board;
determine recency of the plurality of postings in a community, the recency determined by a measure of time since a posting of the plurality of postings was at least one of made or modified;
determine relevancy of the plurality of postings in the community;
determine reputational information of a number of posters of the plurality of postings in the community, the reputational information determined by assessing a reputation for the number of posters;
perform a weighted average calculation based on the recency, the relevancy, and the reputational information; and
present the plurality of postings for the community in an order based on the weighted average calculation.
